(19) United States
(12) Patent Application Publication
(10) Pub. No.: US 2017/0321825 A1
(43) Pub. Date: Nov. 9, 2017

(54) QUICK CONNECT TUBING INSERTION REFERENCE MARKINGS

(71) Applicant: Danco, Inc., Irving, TX (US)

(72) Inventor: Michael J. Schuster, Shorewood, IL (US)

(21) Appl. No.: 15/585,546

(22) Filed: May 3, 2017

Related U.S. Application Data
(60) Provisional application No. 62/331,136, filed on May 3, 2016.

(51) Int. Cl. F16L 11/12; F16L 37/084

(52) U.S. Cl. CPC F16L 11/124; F16L 37/084

(57) ABSTRACT

The embodiments described herein are directed to tubing including insertion reference markings on its outer surface that provide an indicator of how far the tubing is inserted into a fitting. In one embodiment, there is a first insertion reference marking and a second insertion reference marking. A distance between the first insertion reference marking and the second insertion reference marking is a predetermined distance. The first insertion reference marking and the second insertion reference marking provide an indicator of how far the tubing is inserted into a fitting.

### CROSS-REFERENCE TO RELATED APPLICATIONS

This application claims the benefit of U.S. Provisional Application No. 62/331,136, filed May 3, 2016, the entire contents of which are hereby incorporated herein by reference.

### BACKGROUND

Tubing, such as linear low-density polyethylene (LLDPE), polyurethane, nylon, polyethylene, polyvinyl chloride (PVC), or other types of tubing, can provide a good option for water supply lines, including those for drinking water, hot water, plumbing, water-radiant heating systems in commercial applications, and other applications. Combined with quick-connect fittings, push-fit fittings, manifolds, valves and other plumbing components, such tubing provides a quick way to install water pipes in buildings and is suitable for a variety of potable and non-potable plumbing applications.

### BRIEF DESCRIPTION OF THE DRAWINGS

For a more complete understanding of the embodiments and the advantages thereof, reference is now made to the following description, in conjunction with the accompanying figures briefly described as follows:

FIGS. 1A-1C illustrate various positions of a length of tubing with insertion reference markings being inserted into a quick-connect fitting that is shown in a cutaway view, according to an example embodiment described herein.

FIGS. 2-5 illustrate lengths of tubing with insertion reference markings according to example embodiments described herein.

The drawings illustrate only example embodiments and are therefore not to be considered limiting of the scope of the embodiments described herein, as other embodiments are within the scope of this disclosure. The elements and features shown in the drawings are not necessarily drawn to scale, emphasis instead being placed upon clearly illustrating the principles of the embodiments. Additionally, certain dimensions or positionings may be exaggerated to help visually convey certain principles. In the drawings, similar reference numerals between figures designate like or corresponding, but not necessarily the same, elements.

### DETAILED DESCRIPTION

As noted above, tubing, such as linear low-density polyethylene (LLDPE) tubing, can provide a good option for plumbing and water-radiant heating systems in commercial applications. Combined with quick-connect fittings, push-fit fittings, and other fittings, manifolds, valves and other plumbing components, such tubing provides a quick way to install water pipes in buildings and is suitable for a variety of potable and non-potable plumbing applications. One problem which may occur with the use of existing tubing with fittings can arise when tubing is not sufficiently inserted into the fitting to create a watertight seal. Installation of existing tubing without insertion reference markings can be difficult, as there may be no way to tell how far the tubing has been inserted, or whether the tubing is inserted far enough to create a watertight seal. If the outer surface of the tubing is uniform in color, shape, texture, etc., it may be difficult to account for (e.g., measure or quantify) how far the tubing has been inserted. In other words, without an indicator or other means to determine how far tubing has been inserted into a fitting, an individual can inadvertently insert the tubing to an insufficient length for the creation of a watertight seal. However, embodiments described herein include reference markings for tubing that can solve this problem.

The embodiments described herein are directed to tubing, including spaced-apart insertion reference markings that are visible on its outer surface. The insertion reference markings provide a visual indicator of how far the tubing has been inserted into a quick-connect, push-fit, or similar type of fitting, and can be used in various plumbing applications.

During plumbing installations, the tubing can be cut at a reference marking using any suitable cutting tool(s). Then, when inserting the tubing into a quick-connect fitting, it can be inserted to a degree such that the next spaced-apart reference marking is concealed (or nearly concealed) by the fitting. In one embodiment, two reference markings are spaced apart along the tubing at the approximate distance to which it should be inserted into an associated quick-connect fitting to create a watertight seal.

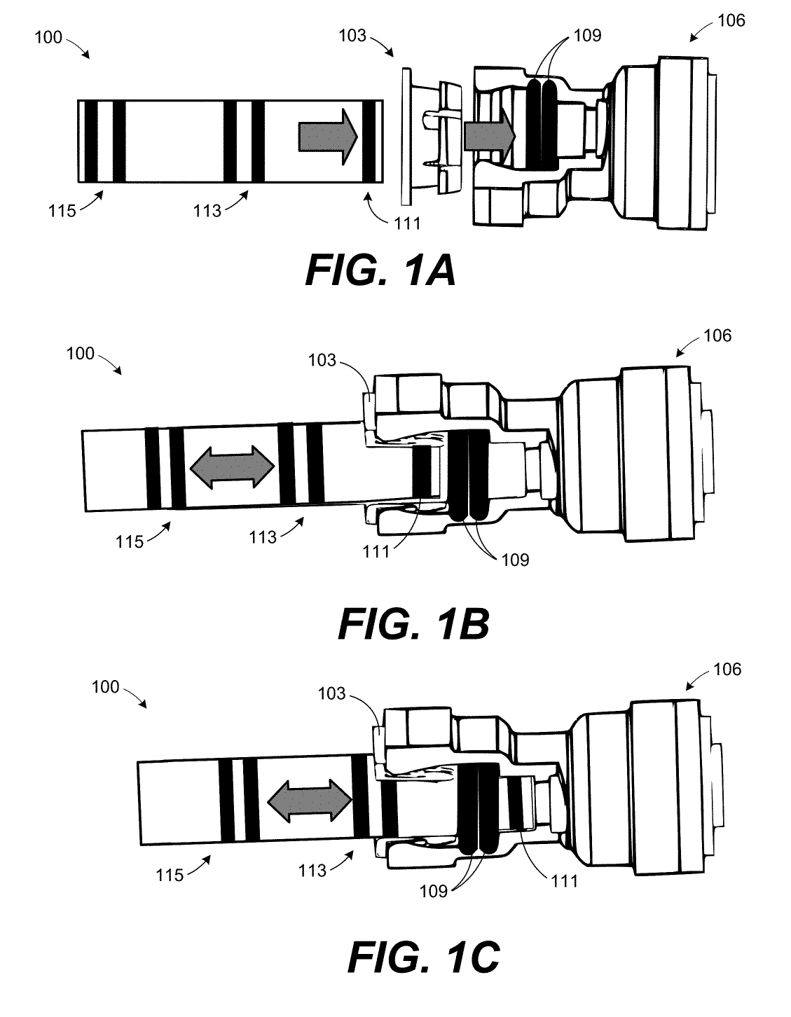

In that context, FIG. 1A illustrates a length of representative tubing 100 and a cutaway view of a representative quick-connect fitting 106. The tubing 100 has insertion reference markings 111, 113, and 115. The insertion reference markings on the tubing 100 can include the insertion reference markings 111, 113, and 115 as well as additional insertion reference markings that can continue along the length of tubing. The insertion reference markings 111, 113, and 115 can provide a visual indicator of how far the tubing 100 has been inserted into the quick-connect fitting 106.

The tubing 100 can be embodied as any suitable type of tubing, such as polyurethane, nylon, polyethylene, LLDPE, polyvinyl chloride (PVC), or other types of tubing, including any known type of rigid and flexible tubing. The tubing 100 can be transparent, translucent, or opaque and can have a particular color. The quick-connect fitting 106 can be embodied as any suitable type of fitting into which the tubing 100 can be inserted to create a watertight seal for plumbing applications. As shown, the quick-connect fitting 106 includes a collet 103 and one or more internal O-rings 109, among other components. The quick-connect fitting 106 can be representative of push fittings and other types of quick-connect fittings.

FIG. 1B illustrates the tubing 100 being inserted into the quick-connect fitting 106 shown in FIG. 1A. In the position shown, the tubing 100 is not inserted far enough into the quick-connect fitting 106 to be compressed fully between the O-rings 109 and the smaller-diameter mating tube within the quick-connect fitting 106, and a seal between the tubing 100 and the quick-connect fitting 106 may fail and water can leak out. However, the insertion reference markings 111, 113, and 115 can prevent insufficient insertion by providing a visual reference during installation.

Installers can take mental note of one or more of the insertion reference markings 111, 113, and 115 while pushing the tubing 100 into the quick-connect fitting 106 to determine whether the tubing has been inserted sufficiently. In some cases, the installer can know how far the tubing must be inserted, and can use the insertion reference markings 111, 113, and 115 as a rough indication of insertion to account for (e.g., measure or quantify) how far the tubing has been inserted. For example, a distance between each of the insertion reference markings 111, 113, and 115 can be designed to be a particular distance, like an inch or a centimeter (or a multiple or fraction thereof), or any particular distance so the installer can quantify or recognize how far the tubing has been inserted.

In other cases, the tubing 100 with insertion reference markings 111, 113, and 115 can be designed for a particular quick-connect fitting 106, or a particular series, set, or type of quick-connect fittings. For example, a distance between each of the insertion reference markings 111, 113, and 115 can be designed to be an approximate distance that the tubing 100 should be inserted into the quick-connect fitting 106 to create a watertight seal. Each insertion reference marking of the tubing 100 can have a number of stripes that circumscribe or partially circumscribe the tubing 100. Each insertion reference marking can include one or more stripes, and each stripe can have its own particular width and length (e.g., fully or partially circumscribing the tubing).

In the example shown in FIGS. 1A-1C, the insertion reference markings 113 and 115 each have two stripes. The tubing 100 has been cut between two stripes, leaving the insertion reference marking 111 as shown with one stripe on this section of tubing. Since the tubing 100 has been cut within the insertion reference marking 111, about at the center of the insertion reference marking 111, and the tubing 100 has not been inserted up to about the center of the insertion reference marking 113, the tubing 100 is not inserted far enough to ensure a watertight seal with the quick-connect fitting 106.

FIG. 1C illustrates the tubing 100 inserted into the quick-connect fitting 106 shown in FIGS. 1A and 1B. In FIG. 1C, the tubing 100 is inserted far enough into the quick-connect fitting 106 to create a watertight seal, for example, by being compressed between the O-rings 109 and the smaller-diameter mating tube within the quick-connect fitting 106.

As discussed above, a distance between each of the insertion reference markings 111, 113, and 115 can be designed to be an approximate distance that the tubing 100 should be inserted into the quick-connect fitting 106 to create a watertight seal. Since the tubing 100 has been cut at about the center of the insertion reference marking 111 and the tubing 100 has been inserted up to about the center of the insertion reference marking 113, the tubing 100 is inserted far enough to ensure a watertight seal with the quick-connect fitting 106. Note that the tubing 100 can be cut at any position, and the installer can nevertheless recognize how far the tubing has been inserted by recalling the cut point with reference to an insertion reference marking and checking whether the tubing 100 has been inserted up to a similar position with reference to the next insertion reference marking on the tubing 100.

In other examples, the distance between each of the insertion reference markings 111, 113, and 115 can be designed to be a particular distance, like an inch, 1.5 inches, a centimeter, or any particular distance so the installer can quantify or recognize how far the tubing has been inserted. For example, for another quick-connect fitting (not shown), the installer can know that the tubing 100 should be inserted one inch to ensure a watertight seal with the other quick-connect fitting. If the distance between each of the insertion reference markings 111, 113, and 115 is two inches, and the tubing 100 is cut at the insertion reference marking 111, then the installer can recognize that the tubing 100 should be inserted to about halfway between the insertion reference marking 111 and the insertion reference marking 113 to ensure a watertight seal with the other quick-connect fitting.

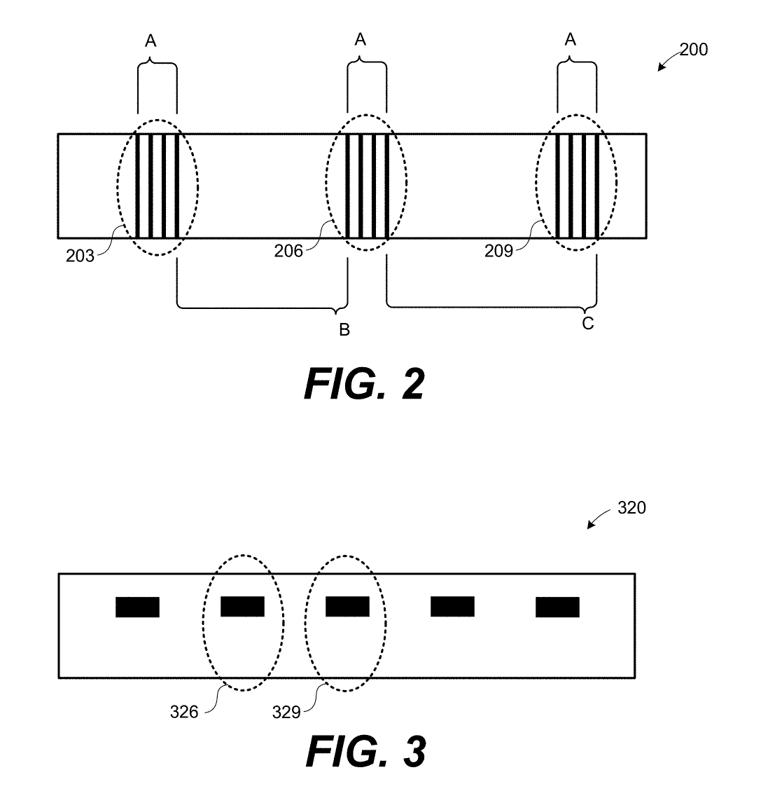

FIG. 2 illustrates a representative length of tubing 200 with insertion reference markings 203-209 according to an example embodiment described herein. The reference markings 203-209 are spaced apart along a length (or one or more portions of the length) of the tubing 200. As shown in FIG. 2A, each of the reference markings 203-209 can include four lines or markings that circumscribe (or partially circumscribe) the outer surface of the tubing 200. In other embodiments, the reference markings 203-209 can include greater or fewer than four lines or markings. Each of the reference markings 203-209 can extend a predetermined length “A” along the tubing 200, and each of the reference markings 203-209 can be spaced apart at a predetermined distance “B” along the tubing 200. In one embodiment, the predetermined length “A” can be from about one-sixteenth to one-quarter of an inch, although greater and lesser lengths are within the scope of the embodiments. The predetermined distance “B” can be designed to match the type or style of quick-connect fittings being used, for example, so that the predetermined distance “B” is an approximate distance that the tubing 200 should be inserted into a particular type or style of quick-connect fittings. In some cases, the predetermined distance “B” can be designed to be a predetermined unit of length, or any particular distance so the installer can quantify or recognize how far the tubing 200 has been inserted.

The reference markings 203-209 provide a visual indicator of how far the tubing 200 should be been inserted into a quick-connect, push-fit, or similar type of fitting. During plumbing installations, the tubing 200 can be cut at one of the reference markings 203-209, such as the reference marking 203. Then, when inserting the tubing 200 into a quick-connect fitting, it can be inserted to a degree such that the next, spaced-apart reference marking 206 is concealed (or nearly concealed) by the fitting. The reference markings 203-209 can be formed on the outer surface of the tubing 200 during (or after) its manufacture in any suitable way, such as using cutting or etching lasers, scoring or cutting tools, paint, printing techniques, or other methods.

FIG. 3 illustrates a length of tubing 320 with insertion reference markings including insertion reference markings 326 and 329, according to an example embodiment described herein. The reference markings can appear in a wide variety of types of markings. In FIG. 3, the insertion reference markings 326 and 329 can be lines or stripes partially circumscribe the tubing 320. Lines, stripes, shapes, characters, and other types of markings can be used. Each of the insertion reference markings 326 and 329 include a rectangular shape or stripe that extends along a length of the tubing 320. In some embodiments, each of the reference markings 326-329 can have two or more rectangular shapes or stripes that extends along a length of the tubing 320, for example on opposite sides of the tubing 320, or at multiple positions around the tubing 320. A distance between each of the insertion reference markings 326-329 can be designed to be any particular distance so the installer can quantify or recognize how far the tubing has been inserted. The distance can be designed to match the type or style of quick-connect fittings being used, for example, so that the distance is an approximate distance that the tubing 320 should be inserted into a particular type or style of quick-connect fittings.

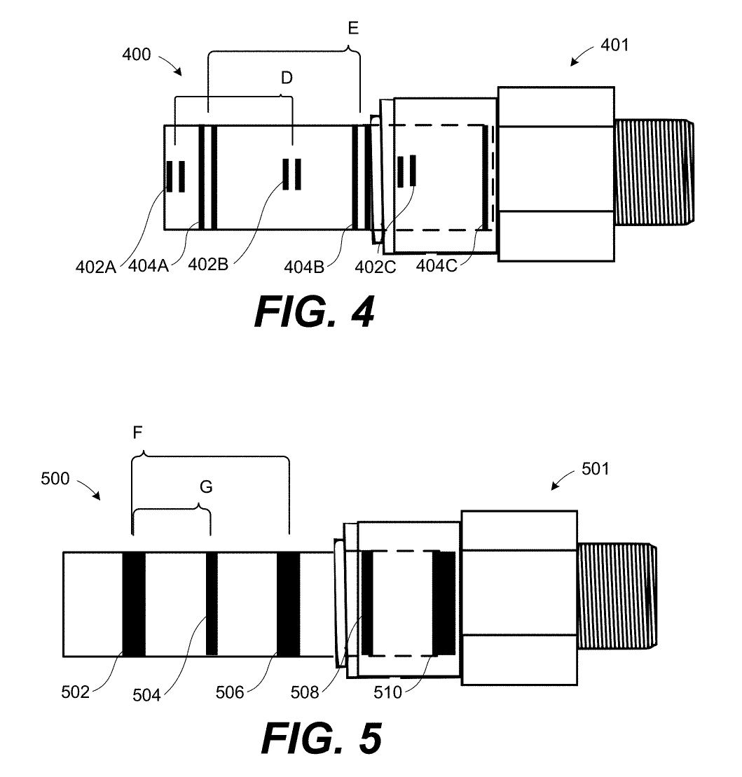

FIG. 4 illustrates a length of tubing 400, inserted into a quick-connect fitting 401 according to an example embodiment described herein. The tubing 400 can have a set of insertion reference markings 402, including insertion reference markings 402A-402C, as well as a set of insertion reference markings 404, including insertion reference markings 404A-404C. The first set of insertion reference markings 402A-402C can each be spaced apart a distance “D” (e.g., center to center). The second set of insertion reference markings 404A-404C can each be spaced apart a distance “E” (e.g., center to center). The distance D can be different from the distance E so the tubing 400 can provide quick reference markings for different types or styles of quick-connect fittings being used. The quick-connect fitting 401 can have a marking that indicates which set of reference markings to use with the quick-connect fitting 401. The quick-connect fitting 401 can have a marking that indicates that it is a particular type of fitting or the particular type of tubing with insertion reference markings to use in conjunction with the fitting. For example, the quick-connect fitting 401 can have a number of lines, a color, a shape, thick or thin line(s), long or short line(s), a number, an identifier, or another type of marking.

The distance E between the insertion reference markings 404A and 404B can be designed so that the distance is an approximate distance that the tubing 400 should be inserted into the quick-connect fitting 401 to ensure a watertight seal. A distance between the markings 404B and 404B can be the same as the distance E. The tubing 400 can be cut at the insertion reference marking 404C and inserted into the quick-connect fitting 401. The reference marking 404B can provide a visual indicator that the tubing 400 is inserted sufficiently to ensure a watertight seal. While not shown, the tubing 400 can also be cut at the insertion reference marking 402A to be inserted into another fitting (e.g., a different type of fitting). The distance D between the insertion reference markings 402A and 402B can be designed so that the distance is an approximate distance that the tubing 400 should be inserted into the other fitting to ensure a watertight seal. The reference marking 402B can provide a visual indicator that the tubing 400 is inserted sufficiently into the other fitting to ensure a watertight seal.

The insertion reference markings 402 can partially circumscribe the tubing 400, while the insertion reference markings 404 can fully circumscribe the tubing 400. In this way, the sets can be separately identified one from the other. While different lengths can be used to separately identify each set of insertion reference markings as shown; colors, lengths, widths, shapes, characters, number of lines, and other types of markings can be used to separately identify each set of insertion reference markings. The set of insertion reference markings 402 can be labelled with a letter, number, name, or other identifier on the tube 400, for example, at one or more of the insertion reference markings 402A-402C. The set of insertion reference markings 404 can be labelled with a different letter, number, name, or other identifier on the tube 400, for example, at one or more of the insertion reference markings 404A-404C.

FIG. 5 illustrates a length of tubing 500, inserted into a quick-connect fitting 501 according to an example embodiment described herein. The tubing 500 can have insertion reference markings 502-510. A distance between each of the insertion reference markings 502-510 can be designed to be a particular distance so the installer can quantify or recognize how far the tubing has been inserted. For example, a predetermined distance between each of the insertion reference markings 502-510 can be ½ inch (or about ½ inch). A distance between the insertion reference markings 502 and 504 can be ½ inch (or about ½ inch), and a distance between the insertion reference markings 502 and 506 can be one inch. In other words, the distance between the thick reference markings 502 and the thin reference marking 504 can be a fraction (e.g., one half or one quarter) of the distance between the thick reference marking 502 and the next thick reference marking 506.

As shown, the insertion reference markings 502, 506, and 510 are wider or thicker than the insertion reference markings 504 and 508 on the tubing 500. Accordingly, different widths of the insertion reference markings can be used much like ruler hatch marks to identify or quantify how far the tubing 500 has been inserted into the quick-connect fitting 501. While different widths can be used to identify units and subunits (e.g., fractions of the units) in FIG. 5, different lengths, colors, shapes, characters, number of lines, and other differences can be used additionally or alternatively. Units can be labelled with a letter, number, name, shape, or other identifier on the tube 500, for example, at one or more of the insertion reference markings 502-510.

The tubing 500 can be cut at the insertion reference marking 510 and inserted into the quick-connect fitting 501. The quick fitting 501 can require the tube 500 to be inserted about ¾ inch to make a watertight seal. In some cases, the quick fitting 501 can include a marking that identifies a length or distance that the tubing 500 should be inserted into the quick-connect fitting 501 to ensure a watertight seal. In the position shown in FIG. 5, an installer can visually quantify that the tubing 500 is inserted into the quick-connect fitting 501 approximately ¾ inch based on the insertion reference markings 502-510. Since the tubing 500 is cut at the insertion reference marking 510, and the insertion reference marking 508 is fully covered by the quick-connect fitting 501, the installer can quantify or estimate that the tubing 500 is inserted a sufficient length to make a watertight seal. The installer can also visually compare the space remaining between the quick-connect fitting 501 and the insertion reference marking 506 to aid the estimation.

As used herein, the term “approximate,” for example in the phrase “approximate distance,” can refer to distance that differs by about 30% or less, about 25% or less, about 20% or less, about 15% or less, about 10% or less, or about 5% or less. The term “or less” can indicate a range that extends to 0% or to 0.01%.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

At least the following is claimed:

1. A system, comprising:
a fitting; and
tubing comprising a plurality of insertion reference markings, the plurality of insertion reference markings comprising a first insertion reference marking and a second insertion reference marking, a distance between the first insertion reference marking and the second insertion reference marking being a predetermined distance, wherein when a portion of the tubing is inserted into the fitting, the insertion reference markings provide an indicator of how far the tubing is inserted into the fitting.

2. The system of claim 1, wherein the predetermined distance is an approximate distance that the tubing should be been inserted into the fitting to create a watertight seal between the tubing and the fitting.

3. The system of claim 1, wherein a length of the first insertion reference marking along the tubing is between one-sixteenth of an inch and one-quarter of an inch.

4. The system of claim 1, wherein the first insertion reference marking comprises at least one line that at least partially circumscribes the tubing.

5. The system of claim 1, wherein the first insertion reference marking comprises four lines that at least partially circumscribe the tubing.

6. The system of claim 1, wherein the plurality of insertion reference markings further comprise a third insertion reference marking, the predetermined distance is a first predetermined distance, and a distance between the first insertion reference marking and the third insertion reference marking is a second predetermined distance, the second predetermined distance being a fraction of the first predetermined distance.

7. The system of claim 6, wherein each of the first insertion reference marking and the second insertion reference marking comprise a first type of marking and the third insertion reference marking comprises a second type of marking.

8. Tubing, comprising:
a first insertion reference marking; and
a second insertion reference marking, a distance between the first insertion reference marking and the second insertion reference marking being a predetermined distance, wherein the first insertion reference marking and the second insertion reference marking provide an indicator of how far the tubing is inserted into a fitting.

9. The tubing of claim 8, wherein the predetermined distance is an approximate distance that the tubing should be inserted into the fitting to create a watertight seal between the tubing and the fitting.

10. The tubing of claim 8, wherein a length of the first insertion reference marking along the tubing is between one-sixteenth of an inch and one-quarter of an inch.

11. The tubing of claim 8, wherein the first insertion reference marking comprises at least one line that at least partially circumscribes the tubing.

12. The tubing of claim 8, wherein the first insertion reference marking comprises four lines that at least partially circumscribe the tubing.

13. The tubing of claim 8, further comprising:
a third insertion reference marking, wherein the predetermined distance is a first predetermined distance, and a distance between the first insertion reference marking and the third insertion reference marking is a second predetermined distance, the second predetermined distance being a fraction of the first predetermined distance.

14. The tubing of claim 13, wherein each of the first insertion reference marking and the second insertion reference marking comprise a first type of marking and the third insertion reference marking comprises a second type of marking.

15. A system, comprising:
a fitting; and
tubing comprising a first insertion reference marking and a second insertion reference marking, a distance between the first insertion reference marking and the second insertion reference marking being a predetermined distance, wherein the first insertion reference marking and the second insertion reference marking provide an indicator of how far the tubing is inserted into a fitting.

16. The system of claim 15, wherein the predetermined distance is an approximate distance that the tubing should be been inserted into the fitting to create a watertight seal between the tubing and the fitting.

17. The system of claim 15, wherein a length of the first insertion reference marking along the tubing is between one-sixteenth of an inch and one-quarter of an inch.

18. The system of claim 15, wherein the first insertion reference marking comprises at least one line that at least partially circumscribes the tubing.

19. The system of claim 15, wherein the first insertion reference marking comprises four lines that at least partially circumscribe the tubing.

20. The system of claim 15, wherein the fitting is a particular type of fitting and the fitting comprises a marking that indicates the particular type of fitting or a particular type of the tubing.
